(19) United States
(12) Patent Application Publication
(10) Pub. No.: US 2013/0018886 A1
(43) Pub. Date: Jan. 17, 2013

(54) EFFECT MEASUREMENT DEVICE, EFFECT MEASUREMENT METHOD, AND EFFECT MEASUREMENT PROGRAM

(71) Applicant: Takeaki Minamizawa, Minato-ku (JP)

(72) Inventor: Takeaki Minamizawa, Minato-ku (JP)

(73) Assignee: NEC CORPORATION, Tokyo (JP)

(21) Appl. No.: 13/580,790

(22) PCT Filed: Jan. 27, 2011
(86) PCT No.: PCT/JP2011/000438

§ 371 Date: Oct. 5, 2012

(30) Foreign Application Priority Data
Feb. 24, 2010 (JP) 2010-039217

(51) Int. Cl. G06F 17/30

(52) U.S. Cl. 707/737; 707/E17.046

(57) ABSTRACT

Segment group generating means 502 generates a segment group as a group of users matching all of a plurality of user attribute-based conditions. Sample group generating means 503 generates a sample group, as a group of users matching a prescribed number of user attribute-based conditions among the plurality of user attribute-based conditions, for each of user attributes corresponding to the condition. Effect measurement means 506 calculates a ratio, regarding the effect of user information on the use of information transmitted by information transmitting means 504, for each user attribute based on usage notifications received by usage notification receiving means 505 from communication terminals of the users in the sample groups.

### TECHNICAL FIELD

The present invention relates to an effect measurement device, an effect measurement method and an effect measurement program for measuring effect of each user information attribute (each attribute included in user information) on the use of information whose destinations (to which the information should be provided or delivered) were determined based on multiple pieces of user information.

BACKGROUND ART

New services implemented by combining various types of information owned by a plurality of business operators are being provided via the Internet. Such new services are generally called mash-up services. In some cases mash-up services are provided in order to lead users to other websites.

Patent Document 1 describes a system that distributes a reward, acquired when a user is led to a website, to concerned parties that contributed to the leading of the user to the website.

Patent Document 2 describes a system in which copyright holders of content acquire shares of profit from each distributor (business operator distributing the content) according to the number of times of distribution by the distributor. In the system, to prevent an unfair report of the number of times of distribution from each distributors, the amount of the shares of profit is determined not using the number of times of distribution but using the number of decryption keys used for the distribution (delivery) of the content to the users.

### CITATION LIST

### Patent Literature

Patent Document 1: JP-A-2008-225968
Patent Document 2: JP-A-2006-155201

### SUMMARY OF INVENTION

### Technical Problem

Both of the systems described in the Patent Documents 1 and 2 distribute the reward according to a preset ratio, without calculating the degree of contribution by each concerned party. Therefore, problems can occur in regard to the appropriateness of the ratio of distribution of the reward. Especially, it is difficult to previously determine an appropriate distribution ratio of a reward that is acquired by use of a variety of information provided by a large number of concerned parties.

It is therefore the primary object of the present invention to provide an effect measurement device, an effect measurement method and an effect measurement program capable of quantitatively calculating the effect of each piece of information, included in multiple pieces of information used for determining the destinations of provision of certain information, on the use of the provided information whose destinations were determined based on the multiple pieces of information.

### Solution to Problem

An effect measurement device in accordance with the present invention comprises: user information storage means which stores user information; segment group generating means which generates a segment group, as a group of users matching all of a plurality of user attribute-based conditions, based on the user information stored in the user information storage means; sample group generating means which generates a sample group, as a group of users matching a prescribed number of user attribute-based conditions among the plurality of user attribute-based conditions, for each of user attributes corresponding to the conditions, based on the user information stored in the user information storage means; information transmitting means which transmits information to communication terminals of users in the segment group generated by the segment group generating means and to communication terminals of users in the sample groups generated by the sample group generating means; usage notification receiving means which receives usage notifications, indicating that the information has been used, from the communication terminals corresponding to the destinations of the transmission of the information by the information transmitting means; and effect measurement means which calculates a ratio, regarding the effect of the user information on the use of the information, for each user attribute based on the usage notifications received by the usage notification receiving means from the communication terminals of the users in the sample groups.

An effect measurement method in accordance with the present invention comprises: generating a segment group, as a group of users matching all of a plurality of user attribute-based conditions, based on user information stored in user information storage means; generating a sample group, as a group of users matching a prescribed number of user attribute-based conditions among the plurality of user attribute-based conditions, for each of user attributes corresponding to the conditions, based on the user information stored in the user information storage means; transmitting information to communication terminals of users in the segment group and to communication terminals of users in the sample groups; receiving usage notifications, indicating that the information has been used, from the communication terminals corresponding to the destinations of the transmission of the information; and calculating a ratio, regarding the effect of the user information on the use of the information, for each user attribute based on the usage notifications received from the communication terminals of the users in the sample groups.

An effect measurement program in accordance with the present invention causes a computer to execute: a segment group generating process of generating a segment group, as a group of users matching all of a plurality of user attribute-based conditions, based on user information stored in user information storage means; a sample group generating process of generating a sample group, as a group of users matching a prescribed number of user attribute-based conditions among the plurality of user attribute-based conditions, for each of user attributes corresponding to the conditions, based on the user information stored in the user information storage means; an information transmitting process of transmitting information to communication terminals of users in the segment group generated in the segment group generating process and to communication terminals of users in the sample groups generated in the sample group generating process; a usage notification receiving process of receiving usage notifications, indicating that the information has been used, from the communication terminals corresponding to the destinations of the transmission of the information by the information transmitting process; and an effect measurement process of calculating a ratio, regarding the effect of the user information on the use of the information, for each user attribute based on the usage notifications received in the usage notification receiving process from the communication terminals of the users in the sample groups.

### Advantageous Effects of the Invention

According to the present invention, the ratio regarding the effect on the use of information supplied to users can be calculated for each user attribute included in user information.

### BRIEF DESCRIPTION OF DRAWINGS

FIG. 1 It depicts a block diagram showing an example of the configuration of an effect measurement device in accordance with a first exemplary embodiment of the present invention.

FIG. 2 It depicts a table showing an example of user information stored in a user information storage unit.

FIG. 3 It depicts a table showing an example of user attribute-based conditions stored in a user attribute effect measurement unit in the first exemplary embodiment.

FIG. 4 It depicts an explanatory diagram showing an example of a segment group and sample groups generated in the first exemplary embodiment.

FIG. 5 It depicts a table showing an example of information indicating the status of use of an advertisement stored in an advertisement usage history storage unit in the first exemplary embodiment.

FIG. 6 It depicts a sequence chart showing the operation of the effect measurement device in accordance with the first exemplary embodiment of the present invention.

FIG. 7 It depicts a table showing an example of the user attribute-based conditions stored in the user attribute effect measurement unit in a second exemplary embodiment of the present invention.

FIG. 8 It depicts an explanatory diagram showing an example of the segment group and the sample groups generated in the second exemplary embodiment.

FIG. 9 It depicts a table showing an example of the information indicating the status of use of the advertisement stored in the advertisement usage history storage unit in the second exemplary embodiment.

FIG. 10 It depicts a block diagram showing an example of the configuration of an effect measurement device in accordance with a third exemplary embodiment of the present invention.

FIG. 11 It depicts a table showing an example of a user attribute-based condition stored in the user attribute effect measurement unit in the third exemplary embodiment.

FIG. 12 It depicts a sequence chart showing the operation of the effect measurement device in accordance with the third exemplary embodiment.

FIG. 13 It depicts a block diagram showing the outline of the present invention.

### DESCRIPTION OF EMBODIMENTS

### First Exemplary Embodiment

A first exemplary embodiment of an effect measurement device in accordance with the present invention will be described below. In order to distribute a reward, acquired from the use of an advertisement delivered to users, to a business operator that provided user information regarding the age, a business operator that provided user information regarding the sex and a business operator that provided user information regarding current positions of users, an effect measurement device 100 in accordance with this exemplary embodiment measures the effect of each user attribute on the use of the advertisement whose delivery destinations were determined based on the various types of user information provided by the business operators.

Incidentally, each attribute type (age, sex, current position) of the user information provided by each business operator will hereinafter be referred to as a “user attribute”. Since the attribute types of the user information provided by the business operators differ from one another in this exemplary embodiment, the measurement of the effect of provided user information will also be referred to as “evaluation of a user attribute”. Users whose user information (e.g., age=34) matches a condition corresponding to a user attribute type (hereinafter referred to also as a “user attribute-based condition” (condition based on a user attribute), e.g., “age=30s”) will also be referred to simply as “users whose user attribute matches”.

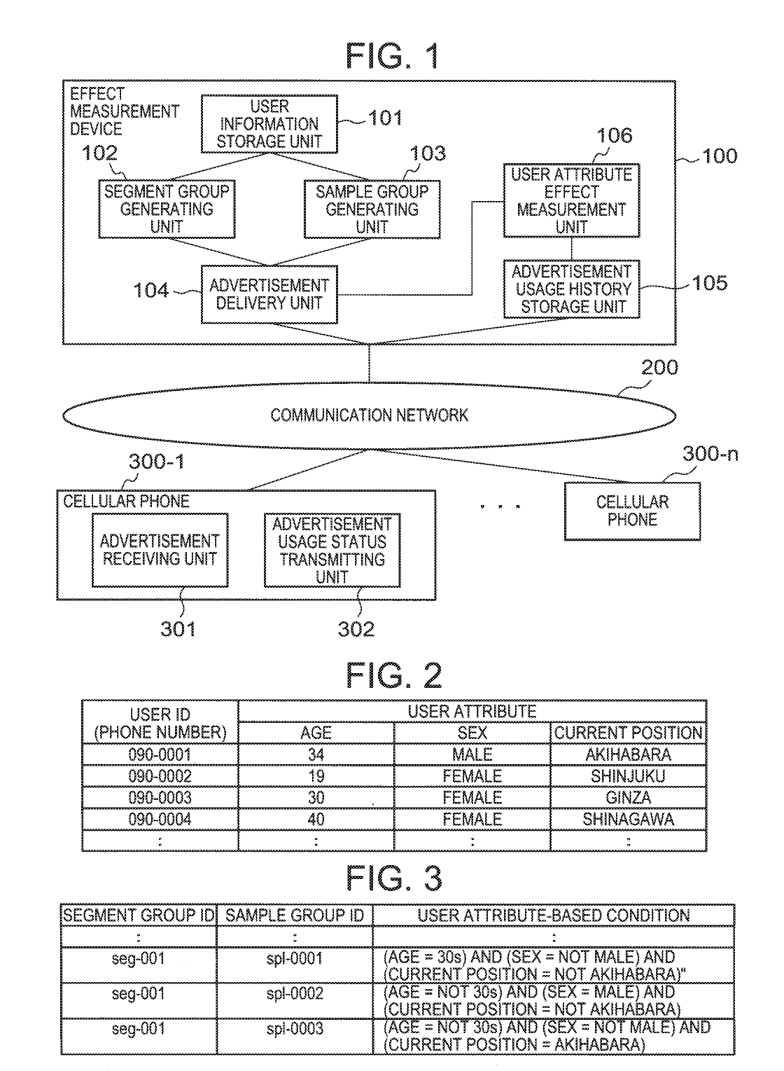

FIG. 1 depicts a block diagram showing an example of the configuration of the effect measurement device 100 in accordance with the first exemplary embodiment of the present invention.

As shown in FIG. 1, the effect measurement device 100 in accordance with the first exemplary embodiment of the present invention is connected to a communication network 200. The communication network 200 can be the Internet or an NGN (Next Generation Network), for example. A plurality of cellular phones 300-1-300-n of users (collectively referred to as “cellular phones 300”) are connected to the communication network 200. The effect measurement device 100 transmits and receives information to/from other devices via the communication network 200. The communication via the communication network 200 may either be wire communication or wireless communication.

The effect measurement device 100 is implemented by, for example, a computer executing processes according to program control. The effect measurement device 100 comprises a user information storage unit 101, a segment group generating unit 102, a sample group generating unit 103, an advertisement delivery unit 104, an advertisement usage history storage unit 105 and a user attribute effect measurement unit 106.

The user information storage unit 101 stores user information on each user which has been provided by a plurality of business operators. The user information is stored in the user information storage unit 101 in regard to each user attribute. Incidentally, the effect measurement device may also be configured to search for and extract the user information from storage devices of the business operators providing the user information, instead of having the user information storage unit 101.

The segment group generating unit 102 searches the user information storage unit 101 for users matching a plurality of prescribed user attribute-based conditions, extracts users of cellular phones 300 as delivery destinations of an advertisement (specifically, identifiers of such users) as the result of the search, and generates a segment group as a group of the extracted users. In this exemplary embodiment, telephone numbers are used as the identifiers of users (hereinafter referred to as “user IDs”). Therefore, when a segment group is generated, telephone numbers of cellular phones 300 as the delivery destinations of an advertisement are determined.

The sample group generating unit 103 searches for users of cellular phones 300 to which the advertisement should be transmitted (delivery destinations) for evaluating a user attribute included in the provided user information by searching the user information storage unit 101 for users matching a prescribed user attribute, and generates a sample group as a group of the users extracted as the result of the search. Specifically, the sample group generating unit 103 extracts the user IDs of users matching one user attribute-based condition (among the plurality of prescribed user attribute-based conditions used by the segment group generating unit 102 for the user search) and not matching the other user attribute-based conditions. Since telephone numbers of cellular phones 300 are used as the user IDs in this exemplary embodiment, when a sample group is generated, telephone numbers of cellular phones 300 to which the advertisement is delivered (delivery destinations) for the evaluation of a user attribute are determined.

The advertisement delivery unit 104 transmits the advertisement to the cellular phones 300 of the users in the segment group generated by the segment group generating unit 102 and to the cellular phones 300 of the users in the sample groups generated by the sample group generating unit 103 via the communication network 200.

The advertisement usage history storage unit 105 receives information indicating the status of use of the advertisement from the cellular phones 300 and stores the received information.

The user attribute effect measurement unit 106 stores the user attribute-based conditions used by the sample group generating unit 103 for generating the sample groups and conducts the evaluation of the user attributes by acquiring the information indicating the status of use of the advertisement from the advertisement usage history storage unit 105. In short, the user attribute effect measurement unit 106 measures the effect of each user attribute on the use of the advertisement (information transmitted to the users). Then, the user attribute effect measurement unit 106 calculates a partition ratio (ratio of distribution) of the reward acquired from the use of the advertisement by the users.

Incidentally, it is assumed in this exemplary embodiment that the client requesting the delivery of the advertisement (hereinafter referred to as an “advertisement delivery requester client”) has previously registered the advertisement to be delivered and information indicating the user attribute-based conditions as the delivery conditions of the advertisement in the advertisement delivery unit 104 of the effect measurement device 100.

Each cellular phone 300 includes an advertisement receiving unit 301 and an advertisement usage status transmitting unit 302. The advertisement receiving unit 301 receives the advertisement transmitted from the effect measurement device 100. While this exemplary embodiment will be described by taking an example of a case where the short message service is used as the method for the advertisement delivery, the advertisements may also be transmitted by use of electronic mails of other types.

The advertisement usage status transmitting unit 302 transmits information indicating the status of use of the advertisement to the effect measurement device 100 via the communication network 200 by using a protocol such as Device Management establish by the standards body OMA (Open Mobile Alliance).

Next, information stored in each component of the effect measurement device 100 will be explained below. FIG. 2 depicts a table showing an example of the user information stored in the user information storage unit 101. As shown in FIG. 2, the age, sex and current position of each user, as values of the user attributes (user attribute values) of each user, have been stored in the user information storage unit 101 in this exemplary embodiment while being associated with the telephone number of the user's cellular phone 300 (i.e., the user ID of the user).

FIG. 3 depicts a table showing an example of the user attribute-based conditions stored in the user attribute effect measurement unit 106. In the user attribute effect measurement unit 106 in this exemplary embodiment, the user attribute-based conditions which have been used for generating the sample groups are stored in a tabular form, while associating each condition (used for generating a sample group) with an identifier of the segment group (hereinafter referred to as a “segment group ID”) and an identifier of the sample group generated for evaluating a user attribute (hereinafter referred to as a “sample group ID”). Incidentally, the segment group ID and the sample group ID may be collectively referred to as “group IDs” in the following description.

In the example of FIG. 3, the user attribute effect measurement unit 106 has stored a user attribute-based condition (made up of a plurality of user attribute-based conditions) “(AGE=30s) AND (SEX=NOT MALE) AND (CURRENT POSITION=NOT AKIHABARA)” while associating it with a segment group ID “seg-0001” and a sample group ID “spl-0001”.

In the example of FIG. 3, the user attribute effect measurement unit 106 has also stored a user attribute-based condition “(AGE=NOT 30s) AND (SEX=MALE) AND (CURRENT POSITION=NOT AKIHABARA)” while associating it with the segment group ID “seg-0001” and a sample group ID “spl-0002”.

In the example of FIG. 3, the user attribute effect measurement unit 106 has also stored a user attribute-based condition “(AGE=NOT 30s) AND (SEX=NOT MALE) AND (CURRENT POSITION=AKIHABARA)” while associating it with the segment group ID “seg-0001” and a sample group ID “spl-0003”.

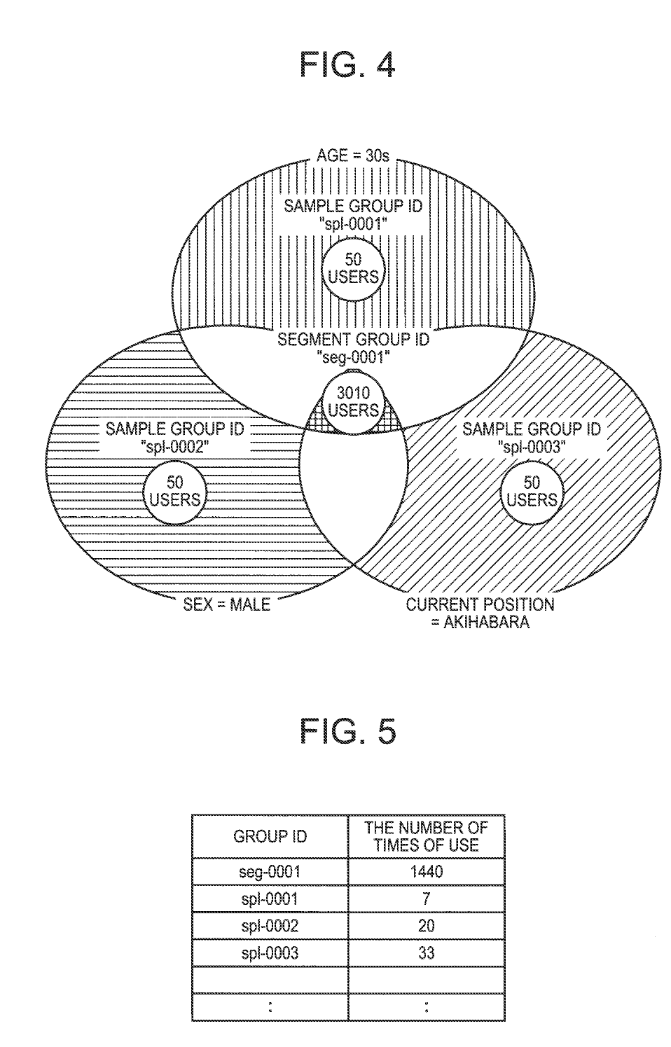

FIG. 4 depicts an explanatory diagram showing an example of the segment group and the sample groups. In FIG. 4, users matching the user attribute-based condition corresponding to the segment group ID “seg-0001” are indicated with a cross-stripe pattern, users matching the user attribute-based condition corresponding to the sample group ID “spl-0001” are indicated with a vertical-stripe pattern, users matching the user attribute-based condition corresponding to the sample group ID “spl-0002” are indicated with a horizontal-stripe pattern, and users matching the user attribute-based condition corresponding to the sample group ID “spl-0003” are indicated with an oblique-stripe pattern.

In the example shown in FIG. 4, the number of users corresponding to the segment group ID “seg-0001” is 3010, the number of users corresponding to the sample group ID “spl-0001” is 50, the number of users corresponding to the sample group ID “spl-0002” is 50, and the number of users corresponding to the sample group ID “spl-0003” is 50.

FIG. 5 depicts a table showing an example of the information indicating the status of use of the advertisement stored in the advertisement usage history storage unit 105. FIG. 5 indicates in a tabular form that the advertisement has been used 1440 times by the users corresponding to the segment group ID “seg-0001”, 7 times by the users corresponding to the sample group ID “spl-0001”, 20 times by the users corresponding to the sample group ID “spl-0002”, and 33 times by the users corresponding to the sample group ID “spl-0003”.

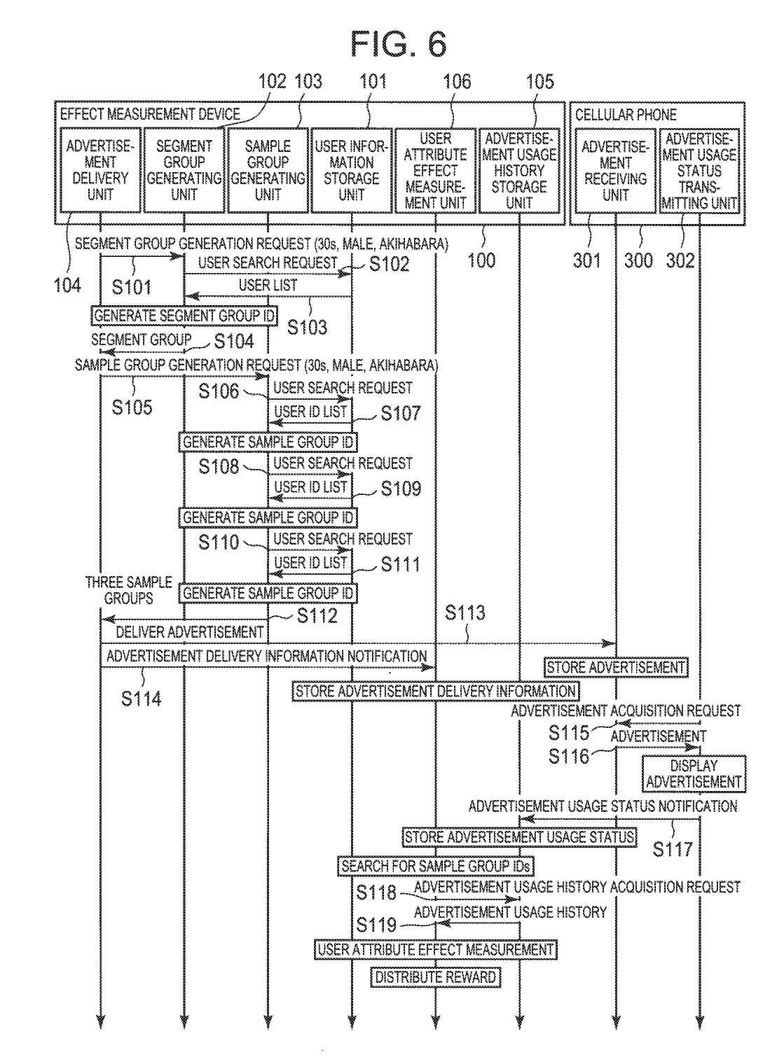

Next, the operation of the effect measurement device 100 in accordance with the first exemplary embodiment of the present invention will be described with reference to figures. FIG. 6 depicts a sequence chart showing the operation of the effect measurement device 100 in accordance with the first exemplary embodiment.

The advertisement delivery unit 104 of the effect measurement device 100 transmits a segment group generation request, including a plurality of user attribute-based conditions, to the segment group generating unit 102 (step S101). For example, the advertisement delivery unit 104 is assumed here to have transmitted a segment group generation request including a plurality of user attribute-based conditions (also referred to simply as “a user attribute-based condition”) “(AGE=30s) AND (SEX=MALE) AND (CURRENT POSITION=AKIHABARA)” to the segment group generating unit 102.

The segment group generating unit 102 transmits a user search request, including the user attribute-based condition (i.e., the plurality of user attribute-based conditions) transmitted from the advertisement delivery unit 104, to the user information storage unit 101 in order to extract users matching the user attribute-based condition (step S102).

The user information storage unit 101 transmits a list of the users matching the user attribute-based condition to the segment group generating unit 102. For example, the user information storage unit 101 transmits a list of user IDs of 3010 users whose age is in 30s, sex is male and current position is Akihabara (including a user having a user ID 090-0001) to the segment group generating unit 102 (step S103).

Incidentally, the segment group generating unit 102 may also be configured to extract the user IDs of the users matching the user attribute-based condition (i.e., the plurality of user attribute-based conditions) transmitted from the advertisement delivery unit 104 from the user information storage unit 101, that is, generate a segment group as a group of the users matching the user attribute-based condition.

The segment group generating unit 102 generates a group identifier (segment group ID) for the user ID list transmitted from the user information storage unit 101 and transmits the user ID list and the segment group ID to the advertisement delivery unit 104 (step S104). For example, the segment group generating unit 102 is assumed here to have generated “seg-0001” as the segment group ID.

The advertisement delivery unit 104 transmits a sample group generation request, including the same user attribute-based condition (i.e., a plurality of user attribute-based conditions) as that transmitted to the segment group generating unit 102 in the step S101, to the sample group generating unit 103 (step S105). For example, the advertisement delivery unit 104 is assumed here to have transmitted a sample group generation request including a user attribute-based condition (i.e., a plurality of user attribute-based conditions) “(AGE=30s) AND (SEX=MALE) AND (CURRENT POSITION=AKIHABARA)” to the sample group generating unit 103.

The sample group generating unit 103 generates as many sample groups (each for evaluating a user attribute) as the user attributes included in the condition transmitted from the advertisement delivery unit 104. In the above example, the sample group generating unit 103 generates three sample groups since the condition transmitted from the advertisement delivery unit 104 includes three user attributes.

In order to generate the first sample group, the sample group generating unit 103 transmits a user search request, including a user attribute-based condition and a user search number (the number of users to be searched for), to the user information storage unit 101 (step S106). When the above example is used, in order to measure the effect of the user attribute value “AGE=30s”, the sample group generating unit 103 sets a negative condition, negating user attributes in the condition specified by the advertisement delivery unit 104 except the user attribute-based condition “AGE=30s”, as the condition for generating the first sample group. Specifically, the sample group generating unit 103 transmits a user search request, including a user attribute-based condition “(AGE=30s) AND (SEX=NOT MALE) AND (CURRENT POSITION=NOT AKIHABARA)” and a user search number “50”, to the user information storage unit 101.

The user information storage unit 101 transmits a list of user IDs of 50 users (=user search number), included in users matching the user attribute-based condition transmitted from the sample group generating unit 103, to the sample group generating unit 103 (step S107). In this exemplary embodiment, the user information storage unit 101 transmits a list of user IDs of users whose age is in 30s, sex is not male and current position is not Akihabara (including a user having a user ID 090-0003) to the sample group generating unit 103.

The sample group generating unit 103 generates an identifier (sample group ID) for the user ID list transmitted from the user information storage unit 101. For example, the sample group generating unit 103 is assumed here to have generated “spl-0001” as the sample group ID.

In order to generate the second sample group, the sample group generating unit 103 transmits a user search request, including a user attribute-based condition and a user search number, to the user information storage unit 101 (step S108). For example, in order to measure the effect of the user attribute value “SEX=MALE”, the sample group generating unit 103 sets a negative condition, negating user attributes in the condition specified by the advertisement delivery unit 104 except the user attribute-based condition “SEX=MALE”, as the condition for generating the second sample group. Specifically, the sample group generating unit 103 transmits a user search request, including a user attribute-based condition “(AGE=NOT 30s) AND (SEX=MALE) AND (CURRENT POSITION=NOT AKIHABARA)” and a user search number “50”, to the user information storage unit 101.

The user information storage unit 101 transmits a list of user IDs of 50 users (=user search number), included in users matching the user attribute-based condition transmitted from the sample group generating unit 103, to the sample group generating unit 103 (step S109).

The sample group generating unit 103 generates an identifier (sample group ID) for the user ID list transmitted from the user information storage unit 101. For example, the sample group generating unit 103 is assumed here to have generated “spl-0002” as the sample group ID.

In order to generate the third sample group, the sample group generating unit 103 transmits a user search request, including a user attribute-based condition and a user search number, to the user information storage unit 101 (step S110). For example, in order to measure the effect of the user attribute value “CURRENT POSITION=AKIHABARA”, the sample group generating unit 103 sets a negative condition, negating user attributes in the condition specified by the advertisement delivery unit 104 except the user attribute-based condition “CURRENT POSITION=AKIHABARA”, as the condition for generating the third sample group. Specifically, the sample group generating unit 103 transmits a user search request, including a user attribute-based condition “(AGE=NOT 30s) AND (SEX=NOT MALE) AND (CURRENT POSITION=AKIHABARA)” and a user search number “50”, to the user information storage unit 101.

The user information storage unit 101 transmits a list of user IDs of 50 users (=user search number), included in users matching the user attribute-based condition transmitted from the sample group generating unit 103, to the sample group generating unit 103 (step S111).

The sample group generating unit 103 generates an identifier (sample group ID) for the user ID list transmitted from the user information storage unit 101. In this exemplary embodiment, the sample group generating unit 103 is assumed here to have generated “spl-0003” as the sample group ID.

Incidentally, the sample group generating unit 103 may also be configured to extract the user IDs of the users matching the user attribute-based condition (transmitted from the advertisement delivery unit 104) from the user information storage unit 101, that is, generate a sample group as a group of the users matching the user attribute-based condition.

The sample group generating unit 103 transmits the sample group IDs of the three sample groups, the user IDs included in each sample group, and each user attribute-based condition (as the effect measurement target of each sample group) to the advertisement delivery unit 104 (step S112).

When the above example is used, the sample group generating unit 103 transmits the sample group ID “spl-0001”, the user ID list regarding the sample group ID “spl-0001”, the user attribute-based condition “AGE=30s”, the sample group ID “spl-0002”, the user ID list regarding the sample group ID “spl-0002”, the user attribute-based condition “SEX=MALE”, the sample group ID “spl-0003”, the user ID list regarding the sample group ID “spl-0003”, and the user attribute-based condition “CURRENT POSITION=AKIHABARA” to the advertisement delivery unit 104.

For each user ID included in the lists acquired from the segment group generating unit 102 and the sample group generating unit 103, the advertisement delivery unit 104 transmits an advertisement including a segment group ID or sample group ID representing the group including the user having the user ID (step S113). The advertisement receiving unit 301 of the cellular phone 300 of such a user receives and stores the advertisement transmitted from the advertisement delivery unit 104.

The advertisement delivery unit 104 is capable of transmitting the advertisements by using a short message service provided by the communication common carrier of the cellular phones 300 since the user IDs are telephone numbers in this exemplary embodiment.

The advertisement delivery unit 104 transmits the segment group ID and the sample group IDs for which the advertisement delivery was carried out and each user attribute-based condition (used as the effect measurement target in each of the sample groups) to the user attribute effect measurement unit 106 as an advertisement delivery information notification (step S114).

In regard to each sample group ID, the user attribute effect measurement unit 106 stores the segment group ID and the user attribute-based condition (used as the effect measurement target in the sample group represented by the sample group ID) based on the advertisement delivery information notification transmitted from the advertisement delivery unit 104.

When an advertisement display operation is performed on a cellular phone 300 by its user, the advertisement usage status transmitting unit 302 of the cellular phone 300 transmits an advertisement acquisition request to the advertisement receiving unit 301 of the cellular phone 300 (step S115).

In this exemplary embodiment, the effect measurement device 100 collects information indicating that the advertisement was displayed on the cellular phone 300, as a usage history record of the advertisement. Information collected by the effect measurement device 100 is not restricted to this information; the effect measurement device 100 may also be configured to collect information indicating that an advertisement selecting (clicking) operation was performed by the user, information indicating that a clicking operation on a link to a web server included in the advertisement was performed by the user, information indicating that the user purchased an item (e.g., commodity) displayed in the advertisement, etc.

The advertisement receiving unit 301 transmits the advertisement requested by the advertisement usage status transmitting unit 302 to the unit 302 (step S116) and makes the unit 302 display the advertisement on display means (not shown). In order to notify the effect measurement device 100 of the status of use of the advertisement, the advertisement usage status transmitting unit 302 transmits an advertisement usage status notification including a group ID (segment group ID or sample group ID) to the advertisement usage history storage unit 105 of the effect measurement device 100 via the communication network 200 (step S117).

The advertisement usage history storage unit 105 of the effect measurement device 100 increments a usage count (the number of times of use) corresponding to the group ID included in the received advertisement usage status notification by 1. Thus, the usage count (the number of times of use) is counted for each segment/sample group. In this exemplary embodiment, when the group ID “spl-0001” is included in the received advertisement usage status notification, the advertisement usage history storage unit 105 increments the usage count corresponding to spl-0001 by 1 in the table shown in FIG. 5.

As above, the effect measurement device 100 collects information on the usage status in regard to the displaying of the advertisement from each cellular phone 300.

Subsequently, the business operator of the effect measurement device 100 distributes the reward (revenue acquired from the advertisement delivery requester client) to the business operators that provided the user information. In this exemplary embodiment, the distribution of the reward regarding the advertisement delivered to the cellular phones 300 of the users corresponding to the segment group ID “seg-0001” will be explained.

First, the user attribute effect measurement unit 106 determines sample group IDs corresponding to the segment group ID from the stored table illustrated in FIG. 3. When the above example is used, the user attribute effect measurement unit 106 determines “spl-0001”, “spl-0002” and “spl-0003” as the sample group IDs corresponding to the segment group ID “seg-0001”.

Subsequently, the user attribute effect measurement unit 106 transmits an advertisement usage history acquisition request including the segment group ID and the sample group IDs to the advertisement usage history storage unit 105 (step S118).

The advertisement usage history storage unit 105 transmits the usage count corresponding to each group ID to the user attribute effect measurement unit 106 (step S119). When the above example is used, the advertisement usage history storage unit 105 transmits “1440” as the advertisement usage count of the segment group ID “seg-0001”, “7” as the advertisement usage count of the sample group ID “spl-0001”, “20” as the advertisement usage count of the sample group ID “spl-0002”, and “33” as the advertisement usage count of the sample group ID “spl-0003” to the user attribute effect measurement unit 106.

Based on the advertisement usage counts transmitted from the advertisement usage history storage unit 105, the user attribute effect measurement unit 106 calculates a ratio regarding the effect of each user attribute on the use of the advertisement. Specifically, the user attribute effect measurement unit 106 calculates a dominance ratio among the user attribute values in regard to the advertisement delivered to the cellular phones 300 of the users in the segment group of the segment group ID “seg-0001” (i.e., ratio among the effects of the user attribute values on the use of the advertisement) as (AGE=30s):(SEX=MALE):(CURRENT POSITION=AKIHABARA)=7:20:33.

In a case where the business operator of the effect measurement device 100 charges the advertisement delivery requester client 10 JPY (Japanese Yen), for example, for a single use of the advertisement by a user corresponding to the segment group ID “seg-0001”, the business operator of the effect measurement device 100 acquires 1440×10 JPY=14400 JPY from the advertisement delivery requester client.

The business operator of the effect measurement device 100 distributes the 14400 JPY acquired from the advertisement delivery requester client to the business operators (that provided the user information) according to the ratio calculated by the user attribute effect measurement unit 106. In the above example, 1680 JPY is distributed to the business operator that provided the user information regarding the age, 4800 JPY is distributed to the business operator that provided the user information regarding the sex, and 7920 JPY is distributed to the business operator that provided the user information regarding the current position.

According to this exemplary embodiment, the ratio regarding the effect on the use of an advertisement transmitted to users can be calculated for each user attribute included in the user information.

Further, the reward acquired from the advertisement delivery requester client can be distributed to the providers (suppliers) of the user information according to the calculated ratio.

Since each provider of user information is allowed to learn how dominant (i.e., effective) the user information it provided was on the effect of the delivered advertisement, the user information providers can find appropriateness in the distributed reward.

### Second Exemplary Embodiment

A second exemplary embodiment of the effect measurement device in accordance with the present invention will be described below. The effect measurement device 100 in the second exemplary embodiment increases the accuracy of the user attribute effect measurement by having the sample group generating unit 103 generate the sample groups by using user attribute combinations closer to the user attribute combination used by the segment group generating unit 102 for generating the segment group.

In the first exemplary embodiment, each sample group was generated from users matching one user attribute-based condition (among the plurality of prescribed user attribute-based conditions used by the segment group generating unit 102 for the user search) and not matching the other user attribute-based conditions. In the second exemplary embodiment, each sample group is generated from users not matching one user attribute-based condition (among the plurality of prescribed user attribute-based conditions used by the segment group generating unit 102 for the user search) and matching the other user attribute-based conditions.

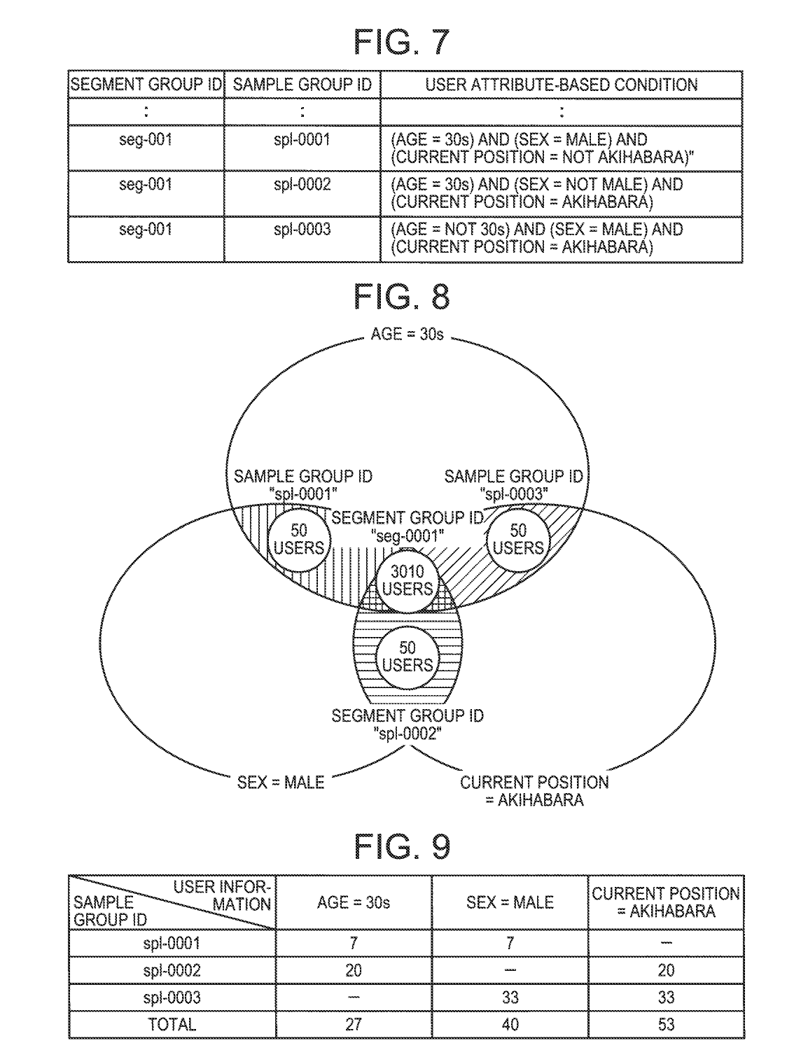

FIG. 7 depicts a table showing an example of the user attribute-based conditions stored in the user attribute effect measurement unit 106 in the second exemplary embodiment. In the example of FIG. 7, the user attribute effect measurement unit 106 has stored a user attribute-based condition “(AGE=30s) AND (SEX=MALE) AND (CURRENT POSITION=NOT AKIHABARA)” while associating it with a segment group ID “seg-0001” and a sample group ID “spl-0001” in a tabular form.

In the example of FIG. 7, the user attribute effect measurement unit 106 has also stored a user attribute-based condition “(AGE=30s) AND (SEX=NOT MALE) AND (CURRENT POSITION=AKIHABARA)” while associating it with the segment group ID “seg-0001” and a sample group ID “spl-0002”.

In the example of FIG. 7, the user attribute effect measurement unit 106 has also stored a user attribute-based condition “(AGE=NOT 30s) AND (SEX=MALE) AND (CURRENT POSITION=AKIHABARA)” while associating it with the segment group ID “seg-0001” and a sample group ID “spl-0003”.

FIG. 8 depicts an explanatory diagram showing an example of the segment group and the sample groups generated in the second exemplary embodiment. In FIG. 8, users matching the user attribute-based condition corresponding to the segment group ID “seg-0001” are indicated with a cross-stripe pattern, users matching the user attribute-based condition corresponding to the sample group ID “spl-0001” are indicated with a vertical-stripe pattern, users matching the user attribute-based condition corresponding to the sample group ID “spl-0002” are indicated with a horizontal-stripe pattern, and users matching the user attribute-based condition corresponding to the sample group ID “spl-0003” are indicated with an oblique-stripe pattern.

In the example shown in FIG. 8, the number of users corresponding to the segment group ID “seg-0001” is 3010, the number of users corresponding to the sample group ID “spl-0001” is 50, the number of users corresponding to the sample group ID “spl-0002” is 50, and the number of users corresponding to the sample group ID “spl-0003” is 50.

FIG. 9 depicts a table showing an example of the information indicating the status of use of the advertisement stored in the advertisement usage history storage unit 105 in the second exemplary embodiment. FIG. 9 indicates that the advertisement has been used 7 times by the users corresponding to the sample group ID “spl-0001”, 20 times by the users corresponding to the sample group ID “spl-0002”, and 33 times by the users corresponding to the sample group ID “spl-0003”.

FIG. 9 shows that the advertisement has been used 27 times by users whose age is in 30s (users corresponding to the sample group ID “spl-0001” and users corresponding to the sample group ID “spl-0002”), 40 times by users whose sex is male (users corresponding to the sample group ID “spl-0001” and users corresponding to the sample group ID “spl-0003”), and 53 times by users whose current position is Akihabara (users corresponding to the sample group ID “spl-0002” and users corresponding to the sample group ID “spl-0003”).

Next, the operation of the effect measurement device 100 in accordance with the second exemplary embodiment of the present invention will be described referring to the sequence chart of FIG. 6 (showing the operation of the effect measurement device 100).

The process from the step S1 (in which the advertisement delivery unit 104 of the effect measurement device 100 in the second exemplary embodiment transmits the segment group generation request including a user attribute-based condition (i.e., a plurality of user attribute-based conditions) to the segment group generating unit 102) to the step S5 (in which the advertisement delivery unit 104 transmits the sample group generation request to the sample group generating unit 103) is equivalent to that in the first exemplary embodiment, and thus repeated explanation thereof is omitted for brevity.

In order to generate the first sample group, the sample group generating unit 103 transmits a user search request, including a user attribute-based condition and a user search number (the number of users to be searched for), to the user information storage unit 101 (step S106). For example, in order to measure the effect of the combination of the user attribute values “AGE=30s” and “SEX=MALE”, the sample group generating unit 103 sets a negative condition, negating only the user attribute “CURRENT POSITION=AKIHABARA” in the condition specified by the advertisement delivery unit 104, as the condition for generating the first sample group. Specifically, the sample group generating unit 103 transmits a user search request, including a user attribute-based condition “(AGE=30s) AND (SEX=MALE) AND (CURRENT POSITION=NOT AKIHABARA)” and a user search number “50”, to the user information storage unit 101.

The user information storage unit 101 transmits a list of user IDs of 50 users (=user search number), included in users matching the user attribute-based condition transmitted from the sample group generating unit 103, to the sample group generating unit 103 (step S107). The sample group generating unit 103 generates an identifier (sample group ID) for the user ID list transmitted from the user information storage unit 101. In this exemplary embodiment, the sample group generating unit 103 is assumed to have generated “spl-0001” as the sample group ID.

In order to generate the second sample group, the sample group generating unit 103 transmits a user search request, including a user attribute-based condition and a user search number, to the user information storage unit 101 (step S108). For example, in order to measure the effect of the combination of the user attribute values “AGE=30s” and “CURRENT POSITION=AKIHABARA”, the sample group generating unit 103 sets a negative condition, negating only the user attribute “SEX=MALE” in the condition specified by the advertisement delivery unit 104, as the condition for generating the second sample group. Specifically, the sample group generating unit 103 transmits a user search request, including a user attribute-based condition “(AGE=30s) AND (SEX=NOT MALE) AND (CURRENT POSITION=AKIHABARA)” and a user search number “50”, to the user information storage unit 101.

The user information storage unit 101 transmits a list of user IDs of 50 users (=user search number), included in users matching the user attribute-based condition transmitted from the sample group generating unit 103, to the sample group generating unit 103 (step S109). The sample group generating unit 103 generates an identifier (sample group ID) for the user ID list transmitted from the user information storage unit 101. For example, the sample group generating unit 103 is assumed here to have generated “spl-0002” as the sample group ID.

In order to generate the third sample group, the sample group generating unit 103 transmits a user search request, including a user attribute-based condition and a user search number, to the user information storage unit 101 (step S110). When the above example is used, in order to measure the effect of the combination of the user attribute values “SEX=MALE” and “CURRENT POSITION=AKIHABARA”, the sample group generating unit 103 sets a negative condition, negating only the user attribute “AGE=30s” in the condition specified by the advertisement delivery unit 104, as the condition for generating the third sample group. Specifically, the sample group generating unit 103 transmits a user search request, including a user attribute-based condition “(AGE=NOT 30s) AND (SEX=MALE) AND (CURRENT POSITION=AKIHABARA)” and a user search number “50”, to the user information storage unit 101.

The user information storage unit 101 transmits a list of user IDs of 50 users (=user search number), included in users matching the user attribute-based condition transmitted from the sample group generating unit 103, to the sample group generating unit 103 (step S111). The sample group generating unit 103 generates an identifier (sample group ID) for the user ID list transmitted from the user information storage unit 101. For example, the sample group generating unit 103 is assumed here to have generated “spl-0003” as the sample group ID.

The sample group generating unit 103 transmits the sample group IDs of the three sample groups, the user IDs included in each sample group, and the user attributes as the effect measurement target of each sample group to the advertisement delivery unit 104 (step S112).

When the above example is used, the sample group generating unit 103 transmits the sample group ID “spl-0001”, the user ID list regarding the sample group ID “spl-0001”, the user attribute-based condition “(AGE=30s) AND (SEX=MALE)”, the sample group ID “spl-0002”, the user ID list regarding the sample group ID “spl-0002”, the user attribute-based condition “(AGE=30s) AND (CURRENT POSITION=AKIHABARA)”, the sample group ID “spl-0003”, the user ID list regarding the sample group ID “spl-0003”, and the user attribute-based condition “(SEX=MALE) AND (CURRENT POSITION=AKIHABARA)” to the advertisement delivery unit 104.

For each user ID included in the lists acquired from the segment group generating unit 102 and the sample group generating unit 103, the advertisement delivery unit 104 transmits an advertisement including a segment group ID or sample group ID representing the group including the user having the user ID (step S113). The advertisement receiving unit 301 of the cellular phone 300 of such a user receives and stores the advertisement transmitted from the advertisement delivery unit 104.

The advertisement delivery unit 104 is capable of transmitting the advertisements by using a short message service provided by the communication common carrier of the cellular phones 300 since the user IDs are telephone numbers in this exemplary embodiment.

The advertisement delivery unit 104 transmits the segment group ID and the sample group IDs for which the advertisement delivery was carried out and each user attribute-based condition (used as the effect measurement target of each of the sample groups) to the user attribute effect measurement unit 106 as the advertisement delivery information notification (step S114).

In regard to each sample group ID, the user attribute effect measurement unit 106 stores the segment group ID and the user attribute-based condition (used as the effect measurement target in the sample group represented by the sample group ID) based on the advertisement delivery information notification transmitted from the advertisement delivery unit 104.

The process executed when the advertisement display operation is performed on a cellular phone 300 by its user, that is, the process from the step S115 (in which the advertisement usage status transmitting unit 302 transmits the advertisement acquisition request to the advertisement receiving unit 301) to the step S117 (in which the advertisement usage history storage unit 105 of the effect measurement device 100 receives and stores the advertisement usage status notification transmitted from the advertisement usage status transmitting unit 302) is equivalent to that in the first exemplary embodiment, and thus repeated explanation thereof is omitted for brevity.

Subsequently, the business operator of the effect measurement device 100 distributes the reward (revenue acquired from the advertisement delivery requester client) to the business operators that provided the user information. For example, the distribution of the reward regarding the advertisement delivered to the cellular phones 300 of the users corresponding to the segment group ID “seg-0001” will be explained here.

First, based on the stored table illustrated in FIG. 7, the user attribute effect measurement unit 106 determines sample group IDs corresponding to the segment group ID and user attributes for which the effect measurement should be performed by using the sample group represented by each sample group ID.

In this exemplary embodiment, the user attribute effect measurement unit 106 determines “spl-0001”, “spl-0002” and “spl-0003” as the sample group IDs corresponding to the segment group ID “seg-0001”, and “(AGE=30s) AND (SEX=MALE)”, “(AGE=30s) AND (CURRENT POSITION=AKIHABARA)” and “(SEX=MALE) AND (CURRENT POSITION=AKIHABARA)” as the combinations of user attribute values used for the effect measurement in each sample group.

Subsequently, the user attribute effect measurement unit 106 transmits the advertisement usage history acquisition request including the segment group ID and the sample group IDs to the advertisement usage history storage unit (step S118).

The advertisement usage history storage unit 105 transmits the usage count which has been counted corresponding to each group ID to the user attribute effect measurement unit 106 (step S119). When the above example is used, the advertisement usage history storage unit 105 transmits “1440” as the advertisement usage count of the segment group ID “seg-0001”, “7” as the advertisement usage count of the sample group ID “spl-0001”, “20” as the advertisement usage count of the sample group ID “spl-0002”, and “33” as the advertisement usage count of the sample group ID “spl-0003” to the user attribute effect measurement unit 106.

The user attribute effect measurement unit 106 in the second exemplary embodiment executes the effect measurement after converting the advertisement usage count of each sample group into usage counts of user attributes, without directly using the advertisement usage counts for determining the ratio among the effects of the user attributes.

For example, the user attribute effect measurement unit 106 converts the usage count of each sample group ID into points (scores) of user attributes whose effects should be measured, by generating a table of the sample group IDs and the user attributes (whose effects should be measured based on the groups) like the one shown in FIG. 9. Specifically, since the usage count of the sample group ID “spl-0001” is 7, the user attribute effect measurement unit 106 gives 7 points to “AGE=30s” and “SEX=MALE” as the combination of user attribute values as the targets of the effect measurement by using the sample group.

Further, since the usage count of the sample group ID “spl-0002” is 20, the user attribute effect measurement unit 106 gives 20 points to “AGE=30s” and “CURRENT POSITION=AKIHABARA” as the combination of user attribute values as the targets of the effect measurement by using the sample group. Similarly, since the usage count of the sample group ID “spl-0003” is 33, the user attribute effect measurement unit 106 gives 33 points to “SEX=MALE” and “CURRENT POSITION=AKIHABARA” as the combination of user attribute values as the targets of the effect measurement by using the sample group.

Then, the user attribute effect measurement unit 106 calculates the sum total of the points of each user attribute and thereby calculates the ratio regarding the effect of each user attribute on the use of the advertisement. Specifically, the user attribute effect measurement unit 106 calculates the dominance ratio among the user attribute values in regard to the advertisement delivered to the cellular phones 300 of the users in the segment group of the segment group ID “seg-0001” (i.e., the ratio among the effects of the user attribute values on the use of the advertisement) as (AGE=30s):(SEX=MALE):(CURRENT POSITION=AKIHABARA)=27:40:53.

In a case where the business operator of the effect measurement device 100 charges the advertisement delivery requester client 10 JPY, for example, for a single use of the advertisement by the users corresponding to the segment group ID “seg-0001” who have used the advertisement 1440 times, the business operator of the effect measurement device 100 acquires 1440×10 JPY=14400 JPY from the advertisement delivery requester client.

The business operator of the effect measurement device 100 distributes the 14400 JPY acquired from the advertisement delivery requester client to the business operators (that provided the user information) according to the ratio calculated by the user attribute effect measurement unit 106. In the above example, 3240 JPY is distributed to the business operator that provided the user information regarding the age, 4800 JPY is distributed to the business operator that provided the user information regarding the sex, and 6360 JPY is distributed to the business operator that provided the user information regarding the current position.

According to this exemplary embodiment, the sample groups are generated by using user attribute combinations closer to the user attribute combination used for generating the segment group, by which the accuracy of the user attribute effect measurement can be increased.

### Third Exemplary Embodiment

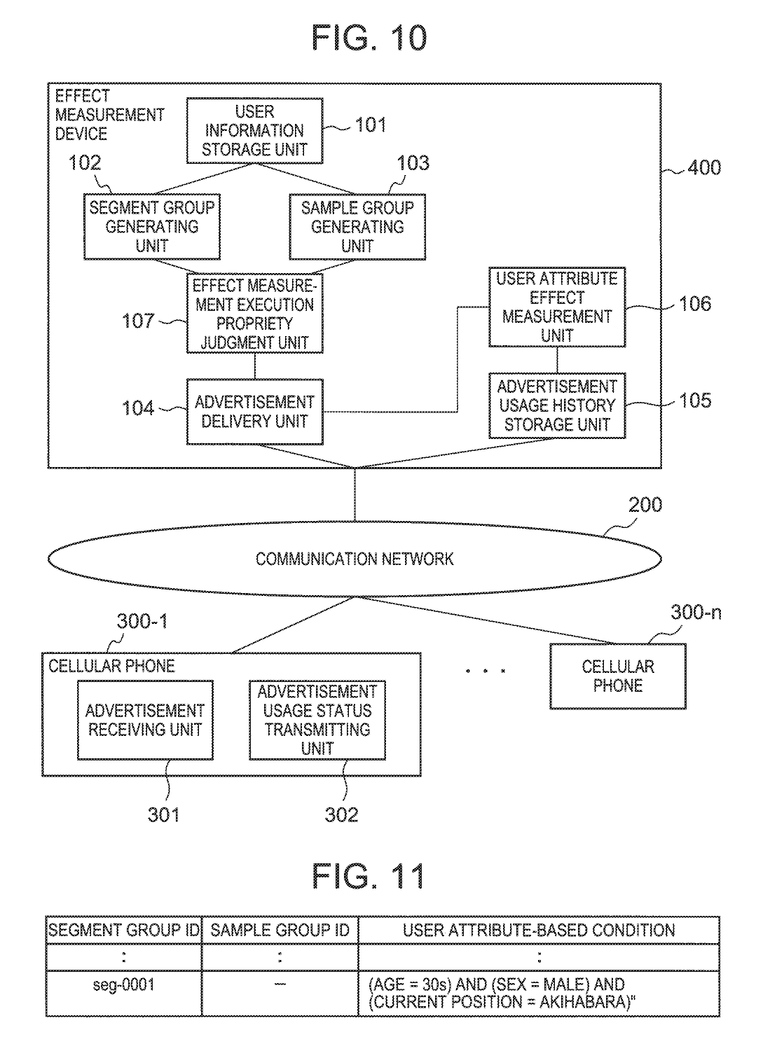

A third exemplary embodiment of the effect measurement device in accordance with the present invention will be described below with reference to figures. FIG. 10 depicts a block diagram showing an example of the configuration of an effect measurement device 400 in accordance with the third exemplary embodiment of the present invention. The effect measurement device 400 in the third exemplary embodiment shown in FIG. 10 comprises an effect measurement execution propriety judgment unit 107 in addition to the components of the effect measurement device 100 in the first exemplary embodiment shown in FIG. 1.

The effect measurement execution propriety judgment unit 107 determines whether or not to execute the user attribute effect measurement based on the number of users included in the segment group generated by the segment group generating unit 102.

FIG. 11 depicts a table showing an example of a user attribute-based condition stored in the user attribute effect measurement unit 106 in the third exemplary embodiment. FIG. 11 indicates that the user attribute effect measurement unit 106 in the third exemplary embodiment has stored “(AGE=30s) AND (SEX=MALE) AND (CURRENT POSITION=AKIHABARA)” as the user attribute-based condition corresponding to a segment group ID “seg-0001”.

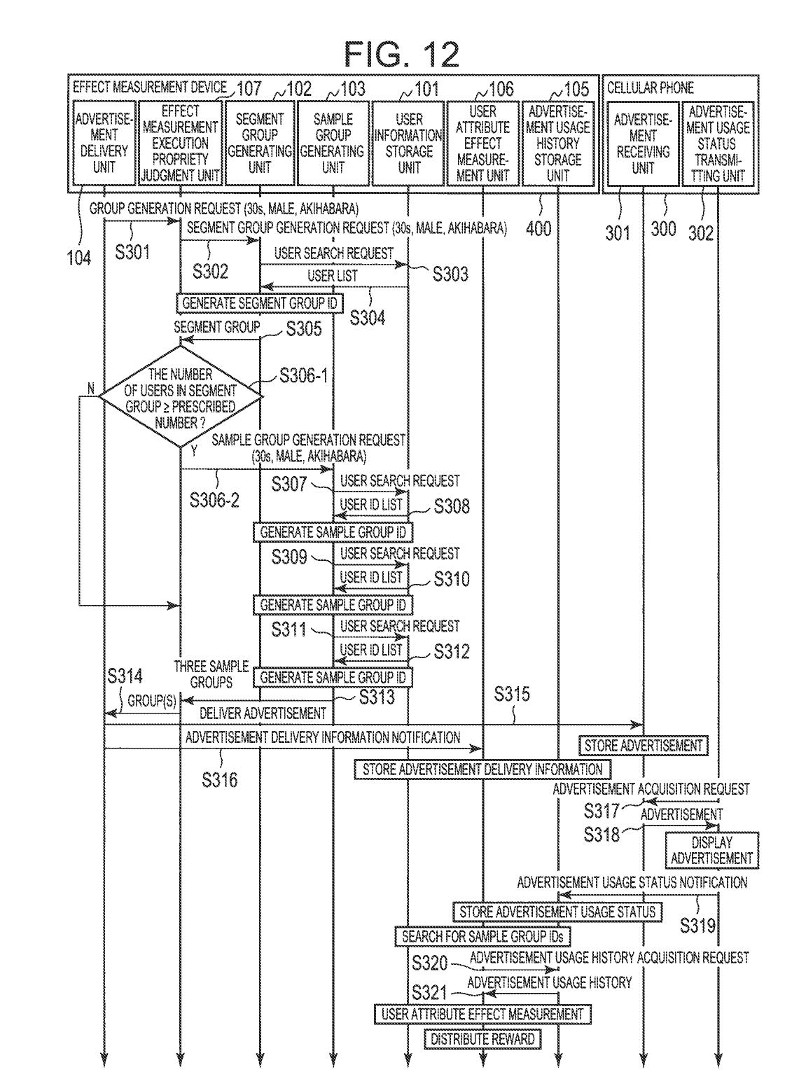

Next, the operation of the effect measurement device 400 in accordance with the third exemplary embodiment of the present invention will be described referring to figures. FIG. 12 depicts a sequence chart showing the operation of the effect measurement device 400 in accordance with the third exemplary embodiment.

The advertisement delivery unit 104 of the effect measurement device 400 transmits a group generation request to the effect measurement execution propriety judgment unit 107 in order to acquire a user group as the destinations of the advertisement delivery (step S301). For example, the advertisement delivery unit 104 is assumed here to have transmitted a group generation request including a user attribute-based condition (i.e., a plurality of user attribute-based conditions) “(AGE=30s) AND (SEX=MALE) AND (CURRENT POSITION=AKIHABARA)” to the effect measurement execution propriety judgment unit 107.

The effect measurement execution propriety judgment unit 107 transmits the segment group generation request, including the user attribute-based condition (i.e., the plurality of user attribute-based conditions), to the segment group generating unit 102 (step S302).

The steps S302-S305 of the effect measurement device 400 shown in FIG. 12 are equivalent to the steps S101-S104 of the effect measurement device 100 in the first exemplary embodiment shown in FIG. 6, and thus repeated explanation thereof is omitted for brevity. In this exemplary embodiment, the segment group generating unit 102 transmits a list of user IDs of the users included in the segment group to the effect measurement execution propriety judgment unit 107.

The effect measurement execution propriety judgment unit 107 receiving the user ID list of the segment group from the segment group generating unit 102 transmits the sample group generation request to the sample group generating unit 103 (step S306-2) similarly to the advertisement delivery unit 104 in the step S105 in the first exemplary embodiment if the number of users included in the segment group is a prescribed number (e.g. 1000) or more (S306-1: Y).

The sample group generating unit 103 receiving the sample group generation request from the effect measurement execution propriety judgment unit 107 executes steps equivalent to the steps S106-S112 in the first exemplary embodiment shown in FIG. 6 (steps S307-S313) and transmits the sample group IDs representing the generated sample groups, the user IDs included in each sample group, and each user attribute-based condition (as the effect measurement target of each sample group) to the effect measurement execution propriety judgment unit 107. Thereafter, the process advances to step S314.

If the number of users included in the segment group is less than the prescribed number (S306-1: N), the effect measurement execution propriety judgment unit 107 directly advances to the step S314 without transmitting the sample group generation request to the sample group generating unit 103.

In the step S314, the effect measurement execution propriety judgment unit 107 transmits the user IDs of the segment group (transmitted from the segment group generating unit 102) to the advertisement delivery unit 104. In the case where the judgment in the step S306-1 is affirmative and the user IDs of each sample group are transmitted from the sample group generating unit 103 in the step S313, the effect measurement execution propriety judgment unit 107 transmits the received user IDs of each sample group to the advertisement delivery unit 104.

In step S315, similarly to the step S113 in the first exemplary embodiment, the advertisement delivery unit 104 transmits the advertisement to the cellular phones 300 of users having the user IDs included in the list(s) transmitted from the effect measurement execution propriety judgment unit 107. Incidentally, in the case where the sample group generating unit 103 generated no sample groups, the advertisement delivery information notification transmitted from the advertisement delivery unit 104 to the user attribute effect measurement unit 106 does not include any sample group IDs and includes only the segment group ID and the user attribute-based condition.

For example, the advertisement delivery unit 104 is assumed hereto have transmitted an advertisement delivery information notification including a segment group ID “seg-0001” and a user attribute-based condition “(AGE=30s) AND (SEX=MALE) AND (CURRENT POSITION=AKIHABARA)” to the user attribute effect measurement unit 106 (step S316).

The user attribute effect measurement unit 106 stores the advertisement delivery information notification transmitted from the advertisement delivery unit 104. It is assumed here, for example, that the advertisement delivery information notification includes no sample group IDs and the memory contents of the user attribute effect measurement unit 106 regarding the sample group IDs are “-” (empty) as shown in FIG. 11.

Steps S317-S319 in which the advertisement is displayed on the cellular phones 300 and the status of use of the advertisement is collected by the advertisement usage history storage unit 105 of the effect measurement device 400 are equivalent to the steps S115-S117 in the first exemplary embodiment shown in FIG. 6, and thus repeated explanation thereof is omitted for brevity.

Subsequently, the business operator of the effect measurement device 400 distributes the reward (revenue acquired from the advertisement delivery requester client) to the business operators that provided the user information. In this exemplary embodiment, the distribution of the reward regarding the advertisement delivered to the cellular phones 300 of the users in the segment group having the segment group ID “seg-0001” will be explained.

First, based on the stored table illustrated in FIG. 11, the user attribute effect measurement unit 106 determines sample group IDs corresponding to the segment group ID. However, the user attribute effect measurement unit 106 fails to acquire the sample group IDs in this exemplary embodiment since no sample group IDs corresponding to the segment group ID “seg-0001” have been stored.

In the case where the effect measurement execution propriety judgment unit 107 made a negative judgment in the step S306-1 based on the number of users in the segment group and no sample groups were generated, the user attribute effect measurement unit 106 distributes the reward acquired by the business operator of the effect measurement device 400 evenly to the business operators that provided the user information, for example, based on the advertisement usage count “1440” of the segment group ID “seg-0001” acquired from the advertisement usage history storage unit 105.

In a case where the business operator of the effect measurement device 400 charges the advertisement delivery requester client 10 JPY, for example, for a single use of the advertisement by a user corresponding to the segment group ID “seg-0001”, the business operator of the effect measurement device 400 acquires 1440×10 JPY=14400 JPY from the advertisement delivery requester client.

Then, the manager of the effect measurement device 400 distributes the 14400 JPY evenly to the business operator that provided the user information regarding the age (4800 JPY), the business operator that provided the user information regarding the sex (4800 JPY), and the business operator that provided the user information regarding the current position (4800 JPY).

When the number of users in the segment group is less than the prescribed number, the number of users in each sample group is also small and it is impossible to determine which user attribute is dominant with high accuracy. Therefore, the effect measurement execution propriety judgment unit 107 in this exemplary embodiment is configured to determine whether to execute the user attribute effect measurement or not based on the number of users in the segment group generated by the segment group generating unit 102. The user attribute effect measurement is executed only when the effects of the user attributes can be measured with high accuracy.

While the age, sex and current position have been used as examples of the user attributes in the exemplary embodiments described above, other user attributes may also be used. Specifically, the status of use of the user's communication terminal (whether the communication terminal is ON or not, during conversation or not, etc.), preference information (e.g., category (sports, movies, shopping, etc.) in which the user is interested), rough address (Tokyo Metropolis, Kanagawa prefecture, etc.) of the user, status (working, leisure, etc.) of the user, etc. may also be used as the user attributes, for example.

While the above exemplary embodiments have been described by assuming that the number of users in each sample group is 50, the exemplary embodiments may also be configured to determine the number of users in each sample group based on the number of users in the segment group. For example, the exemplary embodiments may be configured to determine the number of users in each sample group so that the degree of confidence equals 95% when the number of users in the segment group is regarded as the statistical population and the number of users in each sample group is regarded as the number of samples by employing statistical sampling survey technology.

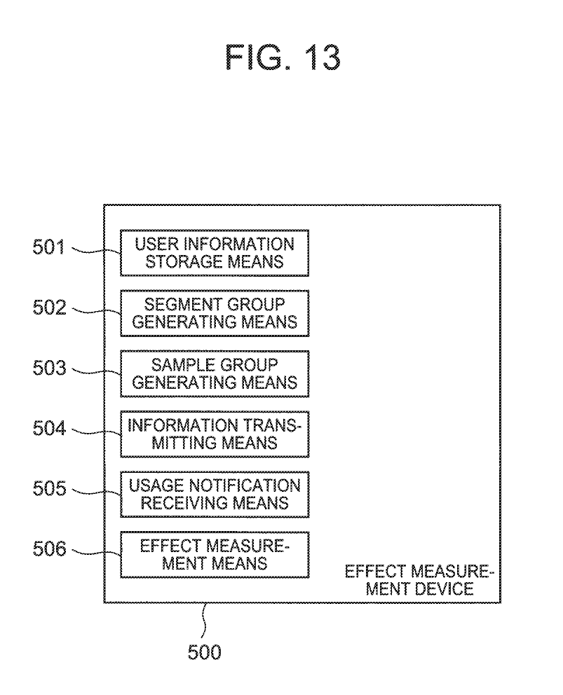

The outline of the present invention will be explained below. FIG. 13 depicts a block diagram showing the outline of the present invention. As shown in FIG. 13, the effect measurement device 500 in accordance with the present invention comprises user information storage means 501, segment group generating means 502, sample group generating means 503, information transmitting means 504 (corresponding to the advertisement delivery unit 104 shown in FIG. 1), usage notification receiving means 505 (corresponding to the advertisement usage history storage unit 105 shown in FIG. 1), and effect measurement means 506 (corresponding to the user attribute effect measurement unit 106 shown in FIG. 1).

The user information storage means 501 stores user information. The segment group generating means 502 generates a segment group, as a group of users matching all of a plurality of user attribute-based conditions, based on the user information stored in the user information storage means 501.

The sample group generating means 503 generates a sample group, as a group of users matching a prescribed number of user attribute-based conditions among the plurality of user attribute-based conditions used by the segment group generating means 502 for generating the segment group, for each of user attributes corresponding to the conditions, based on the user information stored in the user information storage means 501.

The information transmitting means 504 transmits information to communication terminals of users in the segment group generated by the segment group generating means 502 and to communication terminals of users in the sample groups generated by the sample group generating means 503.

The usage notification receiving means 505 receives usage notifications, indicating that the information has been used, from the communication terminals corresponding to the destinations of the transmission of the information by the information transmitting means 504. The effect measurement means 506 calculates a ratio, regarding the effect of the user information on the use of the information transmitted by the information transmitting means 504, for each user attribute based on the usage notifications received by the usage notification receiving means 505 from the communication terminals of the users in the sample groups.

With such a configuration, the ratio regarding the effect on the use of the information supplied to the users can be calculated for each user attribute included in the user information.

The above exemplary embodiments have also disclosed the following effect measurement devices (1)-(4):

(1) The effect measurement device wherein the sample group generating means 503 generates a group of users matching one user attribute-based condition among the plurality of user attribute-based conditions used by the segment group generating means 502 for generating the segment group and not matching the other user attribute-based conditions as the sample group for each of the user attributes.

(2) The effect measurement device wherein the sample group generating means 503 generates a group of users not matching one user attribute-based condition among the plurality of user attribute-based conditions used by the segment group generating means 502 for generating the segment group and matching the other user attribute-based conditions as the sample group for user attributes corresponding to the other user attribute-based conditions.

(3) The effect measurement device comprising effect measurement execution propriety judgment means which requests the sample group generating means 503 to generate the sample groups when the number of users in the segment group generated by the segment group generating means 502 is a prescribed number of more. The sample group generating means 503 generates the sample groups in response to the request from the effect measurement execution propriety judgment means.

(4) The effect measurement device wherein the effect measurement means 506 counts the number of users of the communication terminals that transmitted the usage notifications received by the usage notification receiving means 505 in regard to each sample group and calculates the ratio, regarding the effect of the user information on the use of the information transmitted by the information transmitting means 504, for each user attribute based on the result of the counting in regard to each sample group.

While the present invention has been described above with reference to the exemplary embodiments and examples, the present invention is not to be restricted to the particular illustrative exemplary embodiments and examples. A variety of modifications understandable to those skilled in the art can be made to the configuration and details of the present invention within the scope of the present invention.

This application claims priority to Japanese Patent Application No. 2010-039217 filed on Feb. 24, 2010, the entire disclosure of which is incorporated herein by reference.

### INDUSTRIAL APPLICABILITY

The present invention is applicable to a system that acquires a reward by using information whose destinations are determined based on information provided by a plurality of information providers and distributes the reward to the information providers.

### REFERENCE SIGN LIST

100, 400, 500 effect measurement device
101, 501 user information storage unit 101
102, 502 segment group generating unit
103, 503 sample group generating unit
104 advertisement delivery unit
105 advertisement usage history storage unit
106 user attribute effect measurement unit
107 effect measurement execution propriety judgment unit
200 communication network
300 cellular phone
301 advertisement receiving unit
302 advertisement usage status transmitting unit
504 information transmitting means
505 usage notification receiving means
506 effect measurement means

1-9. (canceled)

10. An effect measurement device comprising:
a user information storage unit which stores user information;
a segment group generating unit which generates a segment group, as a group of users matching all of a plurality of user attribute-based conditions, based on the user information stored in the user information storage unit;
a sample group generating unit which generates a sample group, as a group of users matching a prescribed number of user attribute-based conditions among the plurality of user attribute-based conditions, for each of user attributes corresponding to the conditions, based on the user information stored in the user information storage unit;
an information transmitting unit which transmits information to communication terminals of users in the segment group generated by the segment group generating unit and to communication terminals of users in the sample groups generated by the sample group generating unit;
a usage notification receiving unit which receives usage notifications, indicating that the information has been used, from the communication terminals corresponding to the destinations of the transmission of the information by the information transmitting unit; and
an effect measurement unit which calculates a ratio, regarding the effect of the user information on the use of the information, for each user attribute based on the usage notifications received by the usage notification receiving unit from the communication terminals of the users in the sample groups.

11. The effect measurement device according to claim 10, wherein the sample group generating unit generates a group of users matching one user attribute-based condition among the plurality of user attribute-based conditions used by the segment group generating unit for generating the segment group and not matching the other user attribute-based conditions as the sample group for each of the user attributes.

12. The effect measurement device according to claim 10, wherein the sample group generating unit generates a group of users not matching one user attribute-based condition among the plurality of user attribute-based conditions used by the segment group generating unit for generating the segment group and matching the other user attribute-based conditions as the sample group for user attributes corresponding to the other user attribute-based conditions.

13. The effect measurement device according to claim 10, further comprising an effect measurement execution propriety judgment unit which requests the sample group generating unit to generate the sample groups when the number of users in the segment group generated by the segment group generating unit is a prescribed number of more,
wherein the sample group generating unit generates the sample groups in response to the request from the effect measurement execution propriety judgment unit.

14. The effect measurement device according to claim 10, wherein the effect measurement unit counts the number of users of the communication terminals that transmitted the usage notifications received by the usage notification receiving unit in regard to each sample group and calculates the ratio, regarding the effect of the user information on the use of the information transmitted by the information transmitting unit, for each user attribute based on the result of the counting in regard to each sample group.

15. An effect measurement method comprising:
generating a segment group, as a group of users matching all of a plurality of user attribute-based conditions, based on user information stored in user information storage means;
generating a sample group, as a group of users matching a prescribed number of user attribute-based conditions among the plurality of user attribute-based conditions, for each of user attributes corresponding to the conditions, based on the user information stored in the user information storage means;
transmitting information to communication terminals of users in the segment group and to communication terminals of users in the sample groups;
receiving usage notifications, indicating that the information has been used, from the communication terminals corresponding to the destinations of the transmission of the information; and
calculating a ratio, regarding the effect of the user information on the use of the information, for each user attribute based on the usage notifications received from the communication terminals of the users in the sample groups.

16. The effect measurement method according to claim 15, wherein a group of users matching one user attribute-based condition among the plurality of user attribute-based conditions used for generating the segment group and not matching the other user attribute-based conditions is generated as the sample group for each of the user attributes.

17. A computer readable information recording medium storing an effect measurement program which, when executed by a processor, performs a method comprising:
generating a segment group, as a group of users matching all of a plurality of user attribute-based conditions, based on user information stored in user information storage means;
generating a sample group, as a group of users matching a prescribed number of user attribute-based conditions among the plurality of user attribute-based conditions, for each of user attributes corresponding to the conditions, based on the user information stored in the user information storage means;
transmitting information to communication terminals of users in the segment group generated in the segment group generating process and to communication terminals of users in the generated sample groups;
receiving usage notifications, indicating that the information has been used, from the communication terminals corresponding to the destinations of the transmission of the information; and
calculating a ratio, regarding the effect of the user information on the use of the information, for each user attribute based on the usage notifications received from the communication terminals of the users in the sample groups.

18. The computer readable information recording medium according to claim 17, further comprising:
generating a group of users matching one user attribute-based condition among the plurality of user attribute-based conditions used for generating the segment group and not matching the other user attribute-based conditions as the sample group for each of the user attributes.
